(19) United States
(12) Patent Application Publication
(10) Pub. No.: US 2009/0234520 A1
(43) Pub. Date: Sep. 17, 2009

(54) Communication, Monitor And Control Apparatus, And Related Method, For Railway Traffic

(75) Inventor: Marco Paolacci, Laterina (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: MP S.R.L, San Casciano Val di Pesa (FI) (IT)

(21) Appl. No.: 11/908,662

(22) PCT Filed: Nov. 29, 2005
(86) PCT No.: PCT/IB05/03588

§ 371 Date: Sep. 14, 2007

(30) Foreign Application Priority Data
Mar. 14, 2005 (IT) PI2005A000028
Jul. 22, 2005 (IT) PI2005A000082

(51) Int. Cl. G05D 3/00

(52) U.S. Cl. 701/19

(57) ABSTRACT

An apparatus, and related method, for monitoring and controlling the traffic of public transport means, and in particular railway trains, provides that the position of the trains, equipped with specific devices comprising, among other things, satellite positioning systems, is monitored by a series of centralized units dedicated to control adjacent areas with determined layout and extension of the railway network; the method for monitoring and controlling provides, in case that anomalous traffic situations as well as dangerous situations are detected, sending proper alarm signals and signals for automatically putting into action the breaking means of the vehicles, the devices that are installed in the various vehicles comprising interfacing means for connecting to said breaking means and to sensors placed along the railway paths and in the trains. Said devices also comprise wireless receiving and transmitting means, covering areas concerned with the transit of the vehicles, apt to exchange positioning data or other kind of data of various sensors, among vehicles running within a certain mutual distance, and also apt to starting, if needed, alarm or stop signals of said vehicles. Finally, the devices comprise memory means for storing data, information and parameters concerning the way the means of transport, where the device is installed, works; said memory means being kept in a shock, high temperature, water and dust resistant box in order to preserve the data themselves for future analysis and inspections.

### TECHNICAL FIELD

The present invention refers to a communication, monitor and control apparatus for traffic, in particular for railway trains.

The invention also refers to a method for monitoring and controlling the traffic of railway transport means.

### STATE OF THE ART

As known, at present the traffic of railway vehicles is controlled and monitored by passive or partly passive systems.

The above systems, unchanged since ages, allow, actually, monitoring very roughly the state of railway traffic and they do not perform effective automatic actions to control/stop the trains in case of danger.

It is to consider, for instance, that a train is assumed to be in a certain section of the a railway just since it has been verified its departure, or its transit, from the station where said section of railway begins, and meanwhile, it has not been reported yet its arrival, or its transit, by the staff of the station placed at the end of said section of railway. Nowadays it is not possible to know the exact position of that train, nor, moreover, it is possible to know whether it is moving along that section of railway or it has stopped somewhere in.

Furthermore, as regards the actions which can be externally taken to make the train stop, these actions basically consist of preventing going through a specific section of railway by semaphoring appropriate messages at the ends of the section, whilst at definite points of the section, as, for instance, the points where two different tracks become a single track, are provided special devices, railway markers, dedicated to automatically stop the train when settled and specific conditions occur.

The above control and monitor systems seem to be deficient and inadequate in order to avoid potential dangerous situations, and, more importantly, they are not able to effectively operate when needed.

So, it is worthwhile to develop solutions able to improve the safety level of the above public transport means, in particular trains, both from the point of view of what can be promptly performed in case of danger and from a preventive point of view and to collect data and information useful to reconstruct possible anomalous situations.

It is also worthwhile to be able to use, specially when it concerns railway traffic, services based upon the capability to connect to communication networks, which could be accessed as well by the travellers, and which could also get better communications among the transport means and the controlling and managing centers or, even other institutions concerned.

### SUMMARY OF THE INVENTION

Main object of the present invention is to propose an apparatus, and related method, to monitor in a complete and detailed manner the traffic of public transport means, in particular trains, and to automatically manage said transport means from centralized control stations.

Another object of the present invention is to propose an apparatus, and related method, apt to allow a direct exchange of data and information among public transport means, and in particular trains, in order to monitor their location and to automatically manage said transport means whenever specific dangerous situations occur.

Further object of the invention is to propose an apparatus for public transport means which is highly versatile as regards providing facilities and services for communication purpose, with a special care to safety, granting, in particular, the collection of data and information useful to reconstruct possible anomalous situations.

The aforesaid objects are attained through an apparatus for monitoring and controlling the traffic of public transport means, in particular trains, comprising centralized electronic and computerized units dedicated to control adjacent traffic areas having determined layout and extension, and also comprising devices mounted in every vehicle to be controlled, said devices being connected by satellite communication networks to said centralized units which receive, in continuous, moment after moment, vehicle identification data from each of said devices and, after they have processed said data according to special algorithms stored in said units, they display on specific visualization means distinctive data relating to the position and to other characteristics of every vehicle being in the monitored traffic area and they also provide, in case they detect anomalous traffic situations, to transmit proper alarm signals to said devices as well as signals for operating driving means of the vehicle, driving means that are interfaced with said devices.

The devices mounted in every monitored means of transport advantageously comprise transmitting and receiving means (via radio, telephone, or a different technology) apt, among other things, to directly connect the devices themselves to other devices mounted in vehicles which are within a certain mutual distance, said devices also comprising microcomputer units interfaced with sensors and devices mounted along the railroad as well with sensors and devices mounted in the trains, said microcomputer units being apt to activate alarm units and to control said driving means in order to cause the stop of the vehicle after automatically detected anomalous traffic situations.

The aforesaid devices mounted in every transport means provide for storing possible detected malfunctions as well as all data and parameters relating to the functionality of the train, said storing phase being executable in an encrypted as well as a not encrypted form. Memory means for storing said data and historic parameters are advantageously kept in a shock, high temperature, water and dust resistant box in order to preserve the data themselves for future analysis or inspections.

A method for monitoring and controlling the traffic of public transport means, in particular trains, consists of mounting in said transport means special devices apt to receive and transmit data and signals from and to satellites, spreading, in the area where the traffic has to be monitored, centralized electronic and computerized units dedicated to control adjacent traffic areas with a determined layout and extension, transmitting, by said devices to said centralized units, data pertaining to said transport means where said devices are mounted in, performing by said centralized units definite procedures for processing said data in a manner which is useful to:
defining the position of the transport means which are in the monitored area,
displaying in specific visualization means the geographical location of the transport means in the monitored area,
detecting possible anomalous traffic situations according to stored traffic parameters,
sending to the devices mounted in the vehicles involved in possible anomalous traffic situations, signals which activate alarm procedures and alarm means,
sending to said devices, in case the anomalous situation persists, signals that run breaking means of the vehicles interfaced with said devices.

The method of the invention advantageously provides a direct transmission, via radio or different means, of data and information among devices mounted in vehicles which are within a certain mutual distance and provides as well for automatically activating alarm procedures and drive means of the trains in case that anomalous traffic situations occur, such as unexpected stops or impact alert. According to what above disclosed the advantages of the apparatus, and relating method, of the present invention are immediately clear, relating in particular to the full capability of monitoring and controlling the traffic that can be performed with said apparatus, and also relating to the possibility of an effective and prompt automatic action, if necessary, upon the monitored transport means.

### BRIEF DESCRIPTION OF THE DRAWINGS

Anyway, for a better understanding of the characteristics and the advantages of the present invention, it will now be described, by way of an example, an embodiment of the invention itself, with reference to the accompanying drawings, in which:

FIG. 1 schematically shows the mutual actions of the various components of an apparatus according to the present invention when referring to railway traffic;

FIG. 2 shows an example of data and information visualization in display means mounted in some of the parts of FIG. 1;

FIGS. 3 and 4 show two block diagrams referring to two different components of an apparatus of the invention;

FIG. 5 shows a block diagram of a different embodiment of one of the components of the apparatus.

### DESCRIPTION OF PREFERRED EMBODIMENTS

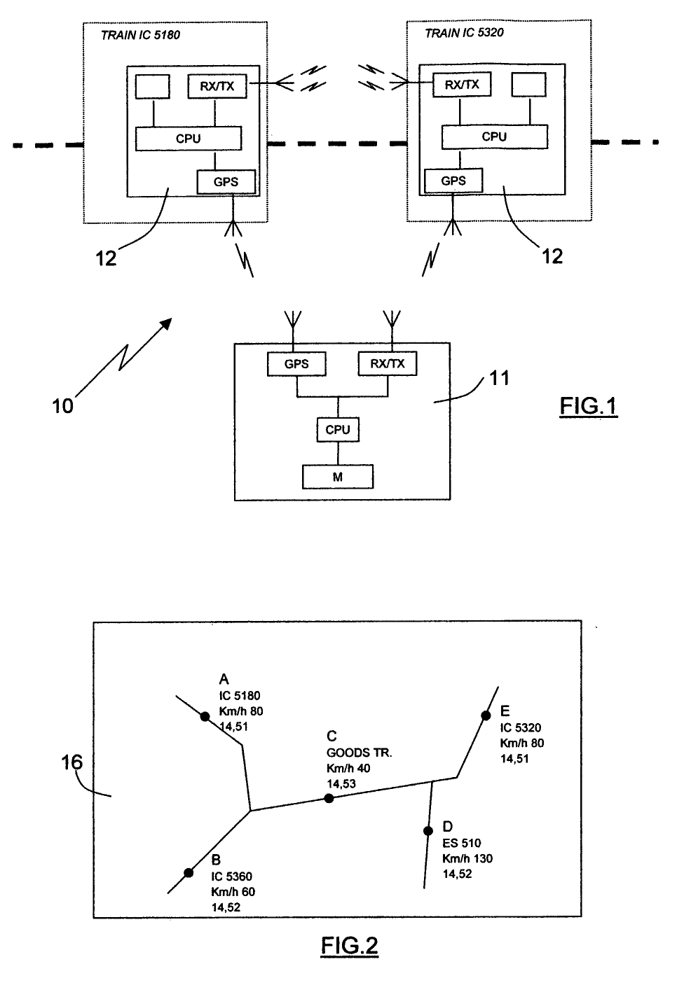

With reference to FIG. 1, it is shown in a very schematic manner the layout of an apparatus, 10, according to the invention, as regards a specific traffic area; it is also schematically shown the mutual actions of the components of said apparatus.

The apparatus is composed, on every specific traffic area, of a unit, 11, intended to monitor and control said area, and devices, 12, mounted in every transport means to be monitored.

Both the centralized unit 11 and the peripheral devices 12 are equipped with via satellite transmission and reception means, via radio in this embodiment of the invention, operating with range and frequencies able to connect every device 12 which is in the monitored area with the centralized unit 11. The via radio transmission and reception means, in particular, are suitable to connect each other devices mounted in transport means whose mutual distance is within a certain range.

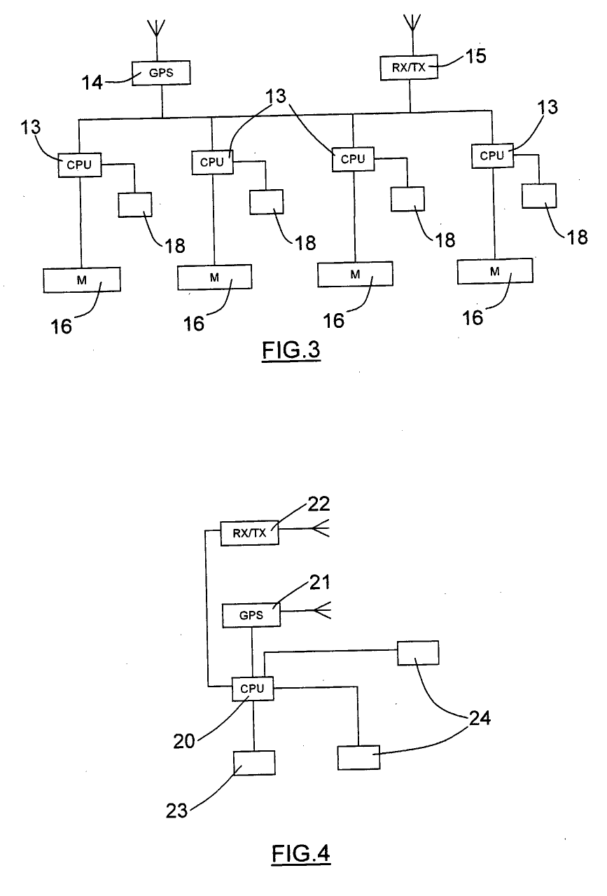

The centralized unit 11, as shown in detail in FIG. 3, is made of one or more processing units, 13, connected by a local network to a receiving/transmitting unit of the GPS type, 14, and to via radio receiving/transmitting units, 15. Said processing units 13 work according to specific procedures dedicated to control their area by using stored data and parameters regarding that particular area, such as timetables, average mileage time, trains identification codes, and others like these ones. The processing units 13 are connected to special display means, 16, and to devices, 18, dedicated to automatically emit signals and control commands after detecting determined or strange traffic situations, or after detecting dangerous situations referring to the practicability of the railway tracks, these dangerous situations being defined by the transmission of proper signals to the centralized units 11 from specific boards or authorities responsible for territory control, from an environmental point of view.

In FIG. 2 is shown a possible visualization, on the display means 16, of data processed by the relating unit 11; in particular, it can be seen, schematically drawn, the path of the railway comprised in the monitored area, and, for each branch of the displayed railway section, are shown the possible vehicles running in it, where, close to the spot indicating its position, are displayed some peculiar identification data of the vehicle itself, such as its number, its speed rate, the time of the last reached survey, or different data or information.

The peripheral devices, mounted in each means of transport to be monitored, comprise a microcomputer unit, 20, connected to via satellite GPS receiving/transmitting units, 21, and to via radio receiving/transmitting units, 22, comprised in the device. This last also comprises interfacing means, to connect with various sensors located along the vehicle in which the device 12 is mounted and interfacing means, 24, to connect with alarm devices installed in said vehicle as well as with drive means of the vehicle itself.

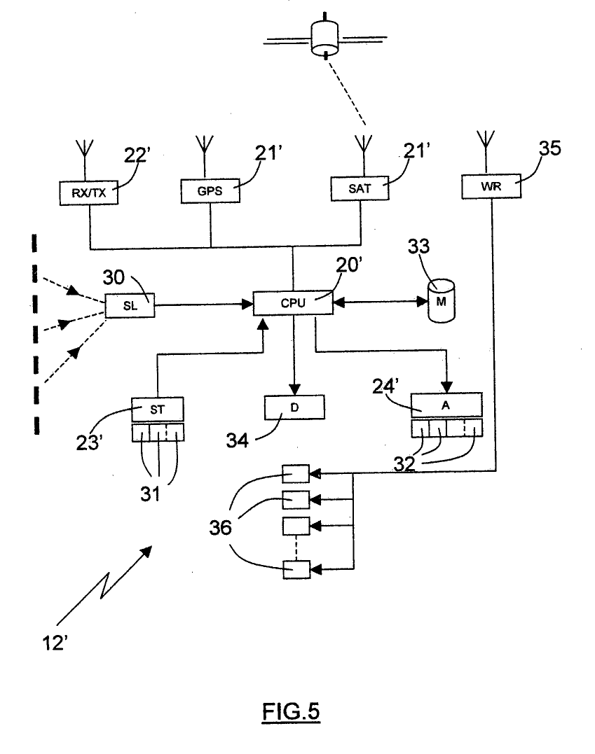

According to a preferred embodiment of the invention, the peripheral devices 12′ comprise, according to what disclosed in the block diagram of FIG. 5:
via radio receiving/transmitting means (22′);
via satellite and GPS receiving/transmitting means (21′);
at least one microcomputer unit (20′);
receiving means (30) to receive signals coming from devices and sensors spread along the railway;
receiving means (23′) to receive signals coming from sensors and devices (31) mounted in the means of transport;
effecting means (24′) to activate devices (32) placed on the means of transport;
memory means (33) to store data, events, and history parameters useful to define how the means of transport has been working;
communication means (34) dedicated to drive the transport means;
receiving/transmitting means (35) to communicate through wireless networks and communication means (36) intended to be used by the travellers.

Both the microcomputer unit, 20′, and the relating interfacing means and the memory means for storing data and parameters are advantageously housed in a thick metallic box provided with adequate protections to resist to heavy mechanical stresses and thermal shocks, as, for instance, collisions up to about an acceleration of 3G, temperatures over 1000° C., and hydraulic pressures over 10 Atm, in order to preserve and keep safe the data in case of anomalous and unattended events, so allowing a later reconstruction of the event for prevention or investigation in general.

The radio receiving/transmitting means, 22′, operate at dedicated frequencies and transmission channels, for example in the range of 450 Mhz, suitable to cover the areas where the monitored railway lays, in order to assure, in every point of the path of the transport means, the direct connection with the devices 12, 12′, mounted in different vehicles which are within a certain distance range, so allowing a prompt exchange of information extremely useful in emergency situations, and also the connection with the devices spread along the railway path is assured, devices which are provided to automatically detect the working condition of the railway itself, as, for instance, the position of the switch points, the position of the semaphores, and the possible engaging of the level crossings, or other conditions and situations.

The receiving/transmitting means, 35, of the WR type, allow connection to wireless networks which, through proper land repeaters, work covering determined areas and branches of the railway network, so providing to the travellers some services and benefits.

To the microcomputer unit, 20′, come, from through the interface means 30, data relating to signals emitted by sensors and devices installed along the railway branches, to automatically detect possible anomalies or to simply report the working conditions as above stated.

To the microcomputer unit, 20′, also come, through the interface means 23′, data relating to signals emitted by sensors and devices, 31, which are in the trains of the vehicle in which the device 12′ is installed. Said sensors and devices comprise units for detecting the status of various mechanical members, such as breaking systems, train fastening means, or others more.

Devices for detecting data or images, such as web-cam or similar, intended, for instance, for public surveillance by police corps, are connected to the communication means, 35, transmitting to wireless networks whereto are also connected terminals, 36, at disposal of the travellers in order to access services, such as POS, internet connection, or similar.

The microcomputer unit, 20′, controls, through the interface means 24′, devices, 32, which are in the vehicle, intended to effect, for example, breaking systems, alarm devices, fire extinguishing systems, or any other system provided to improve safety of the vehicle.

The method for monitoring and controlling traffic of public transport means, in particular railway trains, carried out through the above apparatus provides:
transmitting in continuous mode, by said peripheral devices, 12, 12′, to the centralized units, 11, peculiar identification data of the transport means where they are mounted in;
executing, by said centralized units 11, specific computing procedures to elaborate said data in a way which is useful to:
   determining the position of the transport means which are in the monitored area;
   displaying on proper visualization means the geographical location of the transport means in the monitored traffic area;
   detecting possible anomalous traffic situations comparing with traffic parameters stored in said centralized units;
   sending to the devices, 12, 12′, of the transport means concerned with possible anomalous traffic situations, signals activating procedures and alarm means;
   sending to said devices, 12, 12′, in case the anomalous traffic situation persists, signals activating the breaking means of the vehicle interfaced to said devices.

In particular, the position of the transport means which are in the monitored traffic area is determined through a satellite positioning system.

The method of the invention also provides for a direct transmission, via radio or other means, data and information among devices, 12, 12′, installed in vehicle which run within a certain distance range one from another and also provides for the automatic starting of alarm procedures and putting into action the breaking to means of the vehicles, in case of detection of anomalous traffic situations, such as an unattended stop or a collision alert in single-track branches of the railway. Besides that, the centralized units 11 as well are able to start alarm procedures and to put into action the breaking means of the vehicles as a result of specific signals which come to the units themselves from specific boards or authorities responsible for territory control, from an environmental point of view.

It is also useful to note that when powering the devices 12, 12′, which in a likely way occurs when the means of transport where they are installed begins working, data identifying the vehicle and the driver or drivers are required, and, after memorization of said data, the device 12, 12′, performs a full check of the functionality of the sensors and activating means connected to it and which are controlled by the device itself, and, if are detected anomalies or malfunctioning of the main equipments and systems, a report is sent and the departure of the vehicle is interdicted; otherwise, the device permits the normal work of the means of transport, transmitting to the control centre of the area the relating identification data in order to allow localization and monitoring, according to what above disclosed.

When the device 12, 12′, is put out, it automatically transmits to the control centre of the area data relating to possible anomalies about sensors and activating means detected when the vehicle was running, in order, among the others, to improve both routine and special maintenance procedures of the companies which manage said vehicles.

The advantages arising with the use of the apparatus, and related method, of the present invention are still safe even in presence of modifications and changes to the layout of the apparatus and to the phases of the above disclosed method.

For instance, changes could affect the type and number of the centralized processing units of the various monitored traffic areas; these last, obviously may vary as regard their extension and shape according to the traffic density of a certain area and to the efficiency of the control which can be exercised on that area. The means for transmitting data, information and signals may, as already said, be other than the via radio transmission means shown in the appended embodiments, and they may comprise, for example, mobile phone communication means, GSM, GPRS EDGE or other means.

Other changes or modifications can be brought to the invention still remaining in the field of protection defined by the following claims.

1. An apparatus for monitoring and controlling traffic of public transport means, in particular trains comprising centralized electronic and computerized units (11) dedicated to control adjacent traffic areas having a determined layout and extension, and devices (12, 12′) mounted in every vehicle to be controlled, characterized in that said devices (12) comprise:
receiving/transmitting means apt to connect said devices to said centralized units (11), which continuously receive, at fixed time intervals, from each of said devices (12), identification data of the vehicle where the device is installed and, after they have processed said data according to special algorithms stored in said units, they display on specific visualization means (16) distinctive data relating to the position and to other characteristics of every vehicle being in the monitored traffic area and they also provide, in case they detect anomalous traffic situations, to transmit proper alarm signals to said devices (12) as well as signals for operating driving means of the vehicle, driving means that are interfaced with said devices;
at least one microcomputer unit (20, 20′);
GPS via satellite transmitting and receiving means (21);
further transmitting and receiving means (22, 22′);
interface means (23) to connect to sensors which are in the vehicle where the device (12) is mounted in; and
interface means (24) to connect to alarm devices installed in said vehicle and to driving means of the vehicle.

2. (canceled)

3. The apparatus (10) according to claim 1 characterized in that said further transmitting and receiving means (22) are apt to directly connect each of the devices (12) where are said means, to similar devices mounted in vehicles which are running within a certain distance range.

4. The apparatus (10) according to claim 1 characterized in that said further transmitting and receiving means (22, 22′) comprise radio receiving/transmitting means operating at dedicated frequencies and transmission channels apt to cover the areas where run the transport means in which said devices (12, 12′) are mounted.

5. The apparatus (10) according to claim 1 characterized in that each of said devices (12′) comprises receiving means (30) for receiving signals coming from devices and sensors installed along the railway path.

6. The apparatus (10) according to claim 1 characterized in that each of said devices (12′) comprises memory means (33) for storing data, information and parameters concerning the way of working of the transport means where said device is installed.

7. The apparatus (10) according to claim 6 characterized in that said data, information and parameters are stored in an encrypted form.

8. The apparatus (10) according to claim 6 characterized in that said memory means for storing data and parameters are kept in a shock, high temperature, water and dust resistant box in order to preserve the data in any case for future analysis or inspections.

9. The apparatus according to claim 1 characterized in that each of said devices (12′) comprises receiving/transmitting means (35) towards wireless networks, and communication terminals (36) intended to be used by the travellers, said terminals being directly connected to said receiving/transmitting means communicating through wireless networks.

10. The apparatus according to claim 1 characterized in that said microcomputer control unit (20, 20′) performs, through said device (12, 12′), just as it is powered, a full check of the functionality of the sensors and activating means which are in the vehicle where the device is installed, and, if anomalies or malfunctioning are detected, a report is sent and eventually the departure of the vehicle is interdicted.

11. A method for monitoring and controlling traffic of public transport means, in particular trains, characterized in that it provides:
mounting, in said transport means, devices (12) apt to receive and transmit data and signals,
spreading, in the area where the traffic has to be monitored, centralized electronic and computerized units (11) dedicated to control adjacent traffic areas with a predetermined layout and extension,
transmitting, by said devices (12), to said centralized units (11), identification data pertaining to said transport means where said devices are mounted in,
performing, by said centralized units (1), procedures for processing said data in order to:
define the position of the transport means which are in the monitored area,
display in specific visualization means (16) the geographical location of the transport means in the monitored area,
detect possible anomalous traffic situations with respect to the traffic parameters which are stored in said centralized units (11),
send to the devices (12) mounted in the vehicles involved in possible anomalous traffic situations, signals which activate alarm procedures and alarm means, and
send to said devices (12), in case the anomalous traffic situation persists, signals which run breaking means of the vehicles interfaced with said devices.

12. The method for monitoring and controlling traffic of public transport means according to claim 11 characterized in that the position of the transport means which are in the monitored traffic area is determined through a satellite positioning system.

13. The method for monitoring and controlling traffic of public transport means according to claim 11 characterized in that it provides:
direct transmission, at regular intervals, via radio or other means, of data and information among devices mounted in vehicles which are within a certain distance range one from the other,
automatic starting of alarm procedures in case that anomalous traffic situation are detected, and
automatic starting of breaking means of the vehicles in case that said anomalous traffic situations persist.

14. The method for monitoring and controlling traffic of public transport means according to claim 11 characterized in that it provides the automatic starting of alarm procedures as well as putting into action breaking means of the vehicles as a result of the transmission of proper signals to the centralized units (11) from third parties responsible for territory control and civil defence.

15. The method for monitoring and controlling traffic of public transport means according to claim 11 characterized in that the transmission, by said devices (12), to said centralized units (11), of identification data pertaining to said transport means where said devices are mounted in, is carried out through a via satellite communication system (21′).
